(19) United States
(12) Patent Application Publication
(10) Pub. No.: US 2007/0299890 A1
(43) Pub. Date: Dec. 27, 2007

(54) SYSTEM AND METHOD FOR ARCHIVING RELATIONAL DATABASE DATA

(76) Inventors: David I. Boomer, Seabrook, TX (US); Robert A. Coyne, Friendswood, TX (US); Jonathan Levy, Powell, OH (US); Benny M. Wilbanks, Friendswood, TX (US)

Correspondence Address: HOFFMAN, WARNICK & D'ALESSANDRO LLC, 75 STATE ST, 14TH FLOOR, ALBANY, NY, 12207, US

(21) Appl. No.: 11/425,804

(22) Filed: Jun. 22, 2006

(51) Int. Cl. G06F 17/30

(52) U.S. Cl. 707/204

(57) ABSTRACT

The present invention provides a way to archive relational database data in a Hierarchical Storage Manager (HSM) such as a in a format of the relational database. Specifically, the present invention provides a Virtual File System, (VFS) having an interface for linking a relational database with an HSM such as a High Performance Storage System (HPSS), and a tablespace for receiving the data from the relational database. The VFS can be implemented on a client system that also includes a “mover” for moving the data from the tablespace of the VFS to the HSM.

### BACKGROUND OF THE INVENTION

1. Field of the Invention

The present invention generally relates to data archiving. Specifically, the present invention provides a method for archiving relational database data using a hierarchical storage manager in a format of the relational database (i.e., without having to change the format of the data).

2. Related Art

With the continued pervasiveness of electronic data storage, data archiving has become an increasingly important issue. Specifically, as the quantity of data increases, it is desirable to archive older, lesser used data so that queries and access to newer, more important data can remain at optimal speeds. In general, data archiving techniques include the following: (1) data is archived to other databases. This involves removing it from one database and loading it into another. In some cases the data is available to business queries, in others the data has to be retrieved from the archive tables and loaded into other application databases and tables. However, these other archive databases are constructed on disk technology; (2) data is exported from a production database to flat files. These flat files can be stored in Hierarchical Storage Managers (HSM) taking advantage of less expensive storage media. However, in order to query this data, it first has to be staged from tape to disk and then has to either be reloaded into a database where it can be accessed via normal database interfaces or federated into a database where an additional interface must be used to access the data. This federated flat file data typically has less capability than normal relational (e.g., DB2) table data. In either case, multiple steps are involved in order to make the data available to business queries. These additional steps can potentially be unwieldy and onerous to manage, as well as introducing more complexity into the archival solution; (3) other HSM technology allows the file objects for DB2 data to be managed, but a “file stub” is provided in place of the actual file. When a query attempts to access an HSM-managed table, DB2 accesses the “stub” and the HSM restores the entire file object to disk, replacing the “stub”. This has serious performance implications, especially for larger file objects and SQL that retrieves only a few rows. Additional disk technology may be required in order to satisfy the query demands of the archived data.

Therefore, there exists a need for a solution that solves at least one of the deficiencies of the related art.

### SUMMARY OF THE INVENTION

In general, the present invention provides a way to archive relational database data using a Hierarchical Storage Manager (HSM) in the format of the relational database. Specifically, the present invention provides a Virtual File System (VFS) having an interface for linking a relational database with an HSM such as a High Performance Storage System (HPSS), and a tablespace defined using the VFS for receiving the data from the relational database. The VFS can be implemented on a client system that also includes a “mover” for moving the data from the tablespace of the VFS to the HSM.

A first aspect of the present invention provides a system for archiving relational database data, comprising: a relational database having a set of tables containing data; a hierarchical storage manager having a plurality of storage media; and a Virtual File System (VFS) for linking the relational database with the hierarchical storage manager, wherein the data is archived in the hierarchical storage manager in a format of the relational database.

A second aspect of the present invention provides a system for archiving relational database data, comprising: a relational database having a set of tables containing data; a High Performance Storage System (HPSS) having a plurality of storage media; and a client system having: a Virtual File System (VFS) for linking the relational database with the HPSS, and a HPSS mover for archiving the data in the HPSS in a format of the relational database.

A third aspect of the present invention provides a method for archiving relational database data in a High Performance Storage System (HPSS), comprising: receiving the data in a Virtual File System (VFS) from a DB2 database; and archiving the data in the HPSS in a format of the DB2 database using a HPSS mover.

A fourth aspect of the present invention provides a system for archiving relational database data, comprising: a relational database having a set of tables containing data; a High Performance Storage System (HPSS) having a plurality of storage media; and a client system having: a Virtual File System (VFS) for linking the relational database with the HPSS, and a HPSS mover for retrieving the data directly from the storage media where it resides in HPSS without staging it back to disk, in a format of the relational database.

The present invention also provides related methods and/or program products. Such methods and program products would archive data from a relational database in a HSM (such as a HPSS) via a VFS in a format of the relational database.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a system for archiving relational database data according to the present invention.

FIG. 2 shows an illustrative HPSS architecture according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

The present invention provides a way to archive relational database data in a Hierarchical Storage Manager (HSM) in a format of the relational database. Specifically, the present invention provides a Virtual File System, (VFS) having an interface for linking a relational database with an HSM such as a High Performance Storage System (HPSS), and a tablespace for receiving the data from the relational database. The VFS can be implemented on a client system that also includes a “mover” for moving the data from the tablespace of the VFS to the HSM.

In one specific embodiment, the present invention involves defining the storage structures used by DB2 to reside inside a HPSS via a VFS interface. Existing products and technologies (DB2, DB2 tablespaces, HPSS, VFS) are integrated to provide DB2 with the unique new capability of storing data in relational format on non-traditional low-cost media (tape, MAID, etc) and accessing that data directly via SQL as if it were stored on local disk—enabling the cost-effective storage of hundreds of terabytes to petabytes of relational data.

In general, HPSS is software that manages hundreds of terabytes to petabytes of data on disk and robotic tape libraries. HPSS provides highly flexible and scalable hierarchical storage management that keeps recently used data on disk and less recently used data on tape. HPSS uses cluster and SAN technology to aggregate the capacity and performance of many computers, disks, and tape drives into a single VFS of exceptional size and versatility. This approach enables HPSS to easily meet otherwise unachievable demands of total storage capacity, file sizes, data rates, and number of objects stored. HPSS provides a variety of user and file system interfaces ranging from the VFS interface, ftp, samba and nfs to higher performance pftp, client API, local file mover and third party SAN. The HPSS-VFS becomes a mount point on the system where it is installed. Through this mount point users manipulate the files inside of HPSS (HSM) via file system commands as though they were on more typical file system (disk) mounted to the system.

DB2 stores table definitions inside database objects called tablespaces. The DB2 tablespaces use file system files as containers to store the table data. These container files will reside on the VFS mount point, thus transparently storing table data inside of HPSS. The HPSS VFS will manage the DB2 I/O requests and supply the needed data from inside HPSS regardless of where the data may be in the storage hierarchy, including tape.

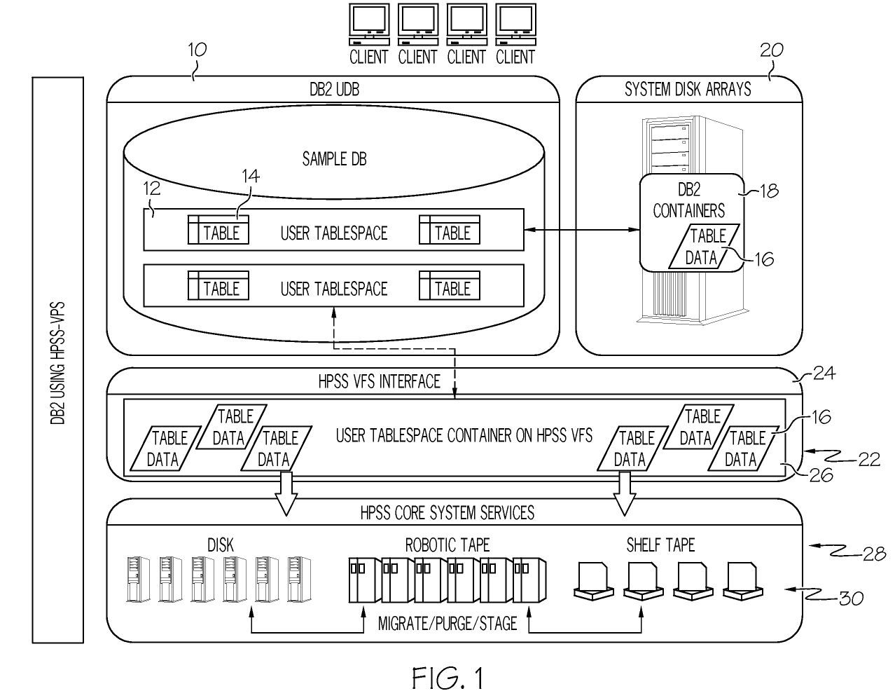

Referring now to FIG. 1, a system for archiving relational database data according to one embodiment (e.g., a DB2 perspective) of the present invention is shown. Specifically, FIG. 1 shows a DB2 (a relational) database 10 having tablespaces 12 containing data tables 14. Data 16 can be received in data tables 14 from a container 18 such as that within a system disk array 20. Relational database 10 communicates with VFS 22 via a VFS interface 24 mounted as a file system, which provides a link/path between DB2 database 10 and HPSS 28 (a type of HSM). As shown, VFS 22 further includes a tablespace container file 26 that stores data 16 for eventual archiving in any of the plurality of storage media 30 of HPSS 28.

Under the present invention, data 16 is stored in tablespace container file 26, and archived in HPSS 28 in a format of DB2 database 10. That is, data 16 need not be converted to any other format (e.g., a flat file format) for archiving in HPSS 28. Specifically, when the container files are created, on VFS 22, they physically exist inside of HPSS 28. HPSS 28 will manage the actual location of the data transparently to DB2 database 10. As the data ages the migration/purge policy will manage when/where and how the data moves up and down the storage hierarchy. This hierarchy can be comprised of up to 5 levels. Typically it starts out on high speed disk and as the data moves down the hierarchy is moved to less expensive media 30. Regardless of where the data resides, it appears to DB2 database 10 as if it is local. HPSS 28 has the capability to read data directly from tape without staging it back to disk. This does not require additional storage to be defined to the solution to account for reading of archived data. As such, queries to archived data can be seamless to an end-user. That is, HPSS 28 appears as any other directory as if the data is stored in DB2 database 10.

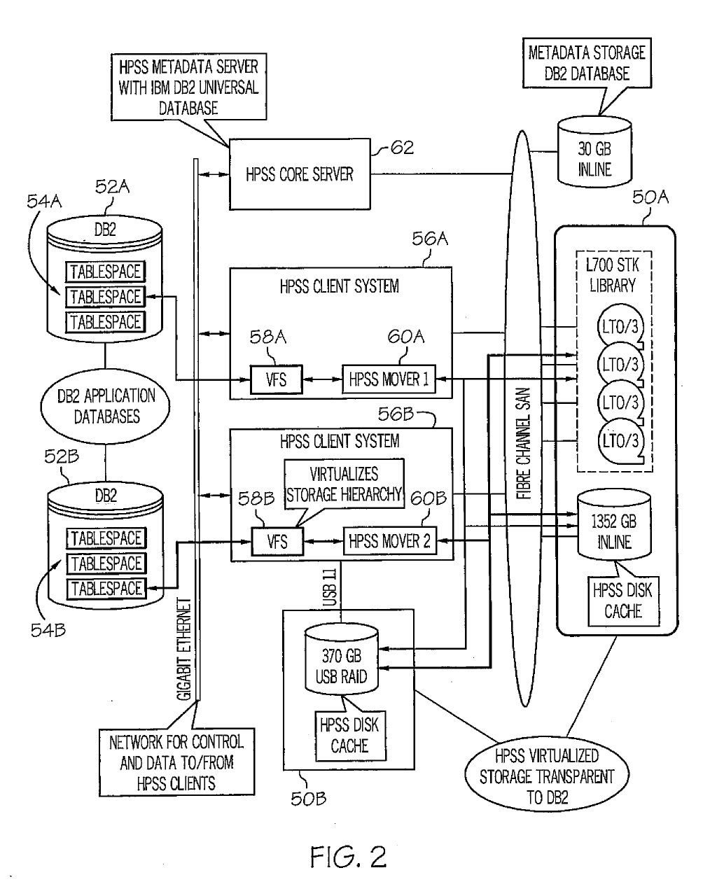

FIG. 2 illustrates an example of HPSS architecture. This example shows the virtualization of the HPSS storage hierarchy 50A-B and how DB2 databases 52A-B would interact with this hierarchy 50A-B. As shown, DB2 databases 52A-B include tablespaces 54A-B (corresponding to tablespaces 12 of FIG. 1) that store data. As further shown, DB2 databases 52A-B communicate with VFS 58A-B of HPSS client system 56A-B. A indicated above, VFS 58A-B link DB2 databases 52A-B with HPSS storage hierarchy 50A-B. Specifically, the data from DB2 databases 52A-B is migrated to VFS 58A-B (i.e., in the DB2 format). Thereafter, HPSS movers 60A-B will migrate the data to HPSS storage hierarchy 50A-B for archiving (i.e., in the DB2 format). FIG. 2 shows additional components of the architecture that are present. For example, architecture can include an HPSS server 62 as well as a meta data storage database 64. HPSS server 62 maintains the definitions of the files stored with HPSS. It describes the path, size, permissions, storage location (within HPSS), etc. of the files archived to HPSS. It is considered a component of the HPSS application.

It should be understood that the present invention is typically computer-implemented via hardware and/or software. As such, and client systems and/or servers will include computerized components as known in the art. Such components typically include (among others), a processing unit, a memory, a bus, input/output (I/O) interfaces, external devices, etc. It should also be understood that although a specific embodiment involving DB2 databases and HPSS has been depicted and described, the present invention could be implemented in conjunction with any type of relational databases and HSMs.

While shown and described herein as a system and method for archiving relational database data, it is understood that the invention further provides various alternative embodiments. For example, in one embodiment, the invention provides a computer-readable/useable medium that includes computer program code to enable a computer infrastructure to archive relational database data. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider could offer to archive relational database data. In this case, the service provider can create, maintain, support, etc., a computer infrastructure, such as computerized infrastructure that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for archiving relational database data. In this case, a computerized infrastructure can be provided and one or more systems for performing the process steps of the invention can be obtained (e.g., created, purchased, used, modified, etc.) and deployed to the computerized infrastructure. To this extent, the deployment of a system can comprise one or more of (1) installing program code on a computing device, such as computer system from a computer-readable medium; (2) adding one or more computing devices to the computer infrastructure; and (3) incorporating and/or modifying one or more existing systems of the computer infrastructure to enable the computerized infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A system for archiving relational database data, comprising:
a relational database having a set of tables containing data;
a hierarchical storage manager having a plurality of storage media; and
a Virtual File System (VFS) for linking the relational database with the hierarchical storage manager, wherein the data is archived in the hierarchical storage manager in a format of the relational database.

2. The system of claim 1, wherein the hierarchical storage manager comprises a high performance storage system.

3. The system of claim 1, wherein the VFS comprises a VFS interface.

4. A system for archiving relational database data, comprising:
a relational database having a set of tables containing data;
a High Performance Storage System (HPSS) having a plurality of storage media; and
a client system having:
a Virtual File System (VFS) for linking the relational database with the HPSS, and
a HPSS mover for archiving the data in the HPSS in a format of the relational database.

5. The system of claim 4, wherein the VFS comprises a VFS interface and a tablespace.

6. A method for archiving relational database data in a High Performance Storage System (HPSS), comprising:
receiving the data in a Virtual File System (VFS) from a DB2 database; and
archiving the data in the HPSS in a format of the DB2 database using a HPSS mover.
